(19) United States
(12) Patent Application Publication
(10) Pub. No.: US 2005/0128698 A1
(43) Pub. Date: Jun. 16, 2005

(54) Cooling fan

(76) Inventor: Cheng Yu Huang, Hsinchung City (TW)

Correspondence Address: TROXELL LAW OFFICE PLLC, SUITE 1404, 5205 LEESBURG PIKE, FALLS CHURCH, VA, 22041, US

(21) Appl. No.: 10/731,505

(22) Filed: Dec. 10, 2003

(51) Int. Cl. G06F 1/16

(52) U.S. Cl. 361/685

(57) ABSTRACT

The present invention discloses a cooling fan having electrical power drawing from the computer, its power line ends have the plugs of the USB, 1394 and PS2 to connect to arbitrary outlets of mobile computer, computer host, or the hub of the USB, 1394 and PS2. The cooling fan includes a basis, a front shell, a rear shell, a fan set, a speed tuner, a power signal line and a connecting plug. The cooling fan also has a recess on the bottom of front side of the basis to support individual card reader, HUB, hard disk or radio device, and additionally has a signal line and plug for connecting to the computer.

### FIELD OF THE INVENTION

The present invention relates to a cooling fan, and more specifically, to a cooling fan drawing electrical power from the computer to turn on the fan for cooling purpose.

### BACKGROUND OF THE INVENTION

Since the computer related peripherals have been continuously researched and innovated, the connections between computer peripherals and the host becomes closer and much frequent and more complicated. Fortunately, the computer makers provide such as Universal Serial Bus (USB), IEEE1394 (6-line), or PS2, connectors and connector outlets to solve in time for the connection issue.

The general connecting system of USB, 1394 and PS2 has 4 lines or 6 lines. Among these lines, there are 2 lines or 4 lines are signal lines for data transport and the other two lines are power lines for low voltage supply (about 5V) and low current supply (500 mA). Therefore, these USB, 1394 and PS2 or connectors are used to the medium for functioning with both data transport and power supply, and have been equipped within the computer, notebook and hub to provide the user for convenient connections and data transfer.

The well-known most benefit of the USB, 1394 and PS2 hub is to connect the peripherals by the bus or collecting nodes and then connects to the computer or to the outlets of the USB, 1394 and PS2 on the host.

As described above of the USB, 1394 and PS2, their HUB connectors and outlets comprise two power lines for supplying low voltage and low current. Accordingly, the inventor herein adapts this property and investigates the necessity of connecting apparatus of the USB, 1394 and PS2 connectors for the computer peripherals so as to draw the electrical power from the USB, 1394 and PS2 of the computer by the computer operator to get a convenient electrical power for a mini cool fan.

The structure of the present invention has a fan set inside the cool fan case and a speed tuner lid on the top. Its power line ends have the plugs of the USB, 1394 and PS2 to connect to mobile computer, arbitrary outlets of the HUB of computer host, the USB, 1394 or PS2 in order to draw electrical power from the USB and 1394 to turn on the fan for cooling purpose.

The embodiment of the present invention, besides of the cool fan function, is capable of having a recess on its basis for the placement of card reader, hub, hard disk or radio device and also having the pen stand for the user to put the pen or electrical pen for writing and pointing to increase its usage.

### SUMMARY OF THE INVENTION

The present invention provides a mini cool fan capable of connecting to any outlets of the USB, 1394 and PS2, characterized in that there is a fan inside the cool fan case. Its power line ends have the plugs of the USB, 1394 and PS2 to connect to arbitrary outlets of mobile computer, computer host, or the hub of the USB, 1394 and PS2 in order to draw electrical power to turn on the fan for cooling purpose. The embodiment of the present invention is capable of having a recess on its basis for the placement of card reader, hub, hard disk or radio device to increase its usage.

### BRIEF DESCRIPTION OF THE DRAWINGS

FIG. 1 is a perspective view of a cooling fan of the invention;

FIG. 2 is an exploded perspective view of a cooling fan of the invention;

FIG. 3 is an illustrative diagram of a cooling fan of the invention additionally with card reader, hub, hard disk, or radio device.

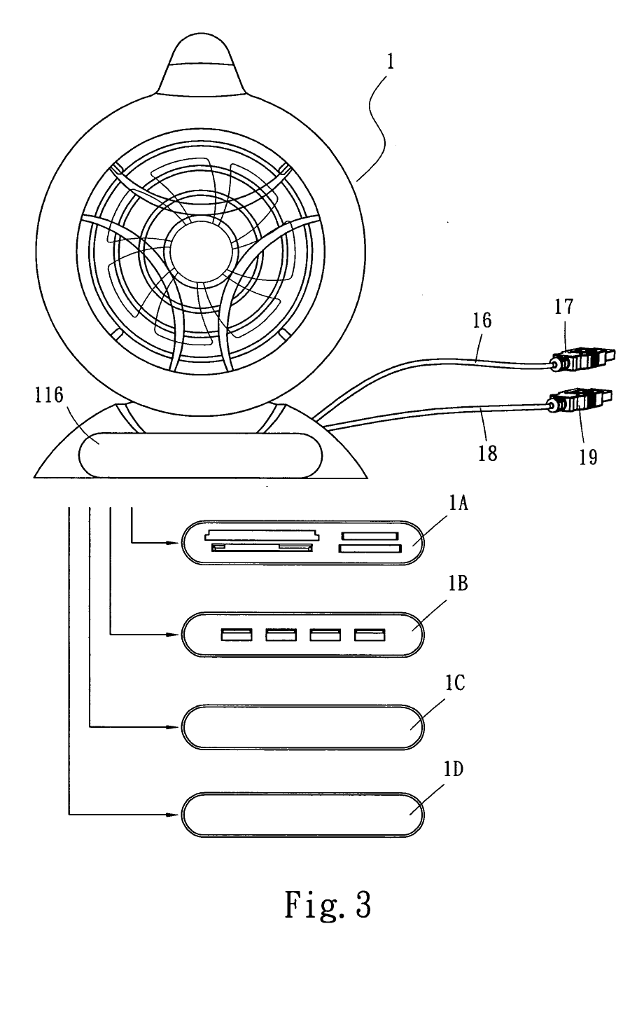

### DETAILED DESCRIPTION OF THE PREFERRED EMBODIMENTS

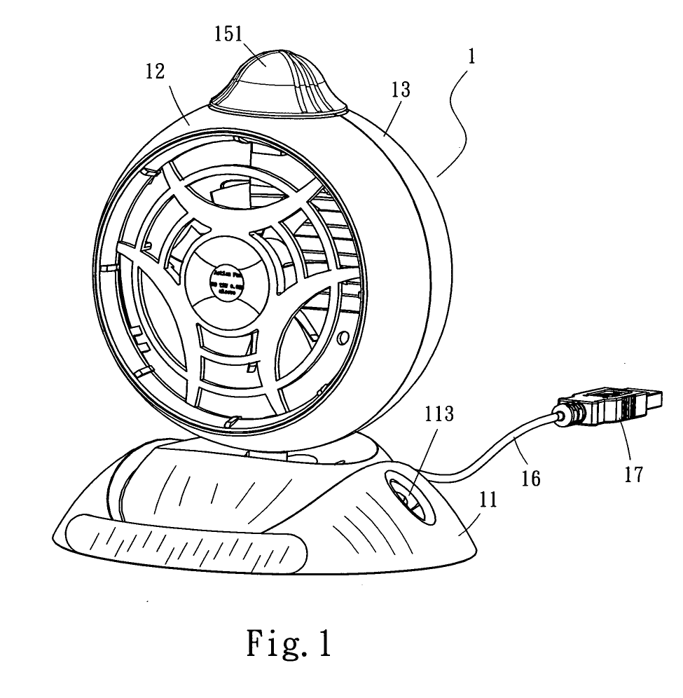

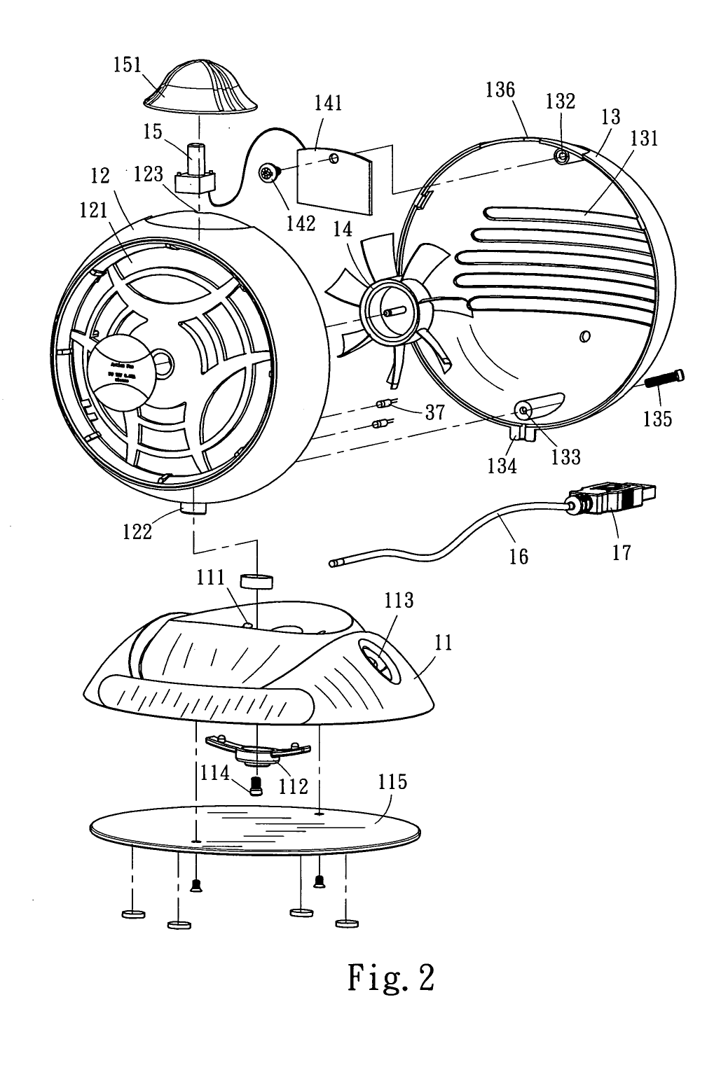

Referring to FIG. 1 and FIG. 2, the present invented cool fan (1) includes a basis (11), a front shell (12), a rear shell (13), a fan set (14), a speed tuner (15), a power signal line (16) and a connecting plug (17).

The basis (11) has an adjustable positioning hole (111), a positioning reed (112) on the bottom and a pen stand (113) on the side.

There fixed a fan set (14) on the center inside the front shell (12) and has a blowing net (121) on the front rim, also there is a half circle thread of a screw (122) on the bottom of the front shell (12), and there is a inlet (131) on the back of the rear shell (13), its inner proper position places screw threads (132), (133) and a half circle screw thread (134).

The PCB (141) board of a controlled fan set (14) is fixed by a screw (142) on the screw thread (132) of the rear shell (13). After binding both the front shell (12) and rear shell (13) by a screw (135) being screwing into a ball shape, the PCB board (141) connecting to a signal line (16) draws out from the back of the rear shell (13) and having connecting plug (17) on its line end.

The basis (11) described above uses a screw (114) screwing through the positioning reed (112) and into the half circle screw threads (122) and (134) on the bottom of both the front shell (12) and the rear shell (13) to form a ball-shaped combination. The elevation angle of the cool fan (1) is adjustable by the positioning reed (112) and there covers a bottom board (115) on the basis (11) bottom.

The contact top of the front shell (12) and the rear shell (13) described above has holes (123) and (136) to fix the position of rotating speed tuner, and there is an arc knob (151) placed on the top for the user to adjust and control rotating speed of the fan (14). The fan (14) is capable of with light (the current fan suppliers provide fans with light), or additionally places an LED light (137) inside the front shell (12) to have a lighting effect for the front shell (13) of the present invention while turn-on the cool fan (14). Accordingly, the present invented cool fan (1) is to use the USB, 1394 and PS2 plugs (17) connecting to the outlets of the computer or hub to offer the cool fan (1) for work. The lighting appearance from the fan (14) has technical and secret feel, also the arc knob (151) can adjust rotating speed of the fan (14).

AS FIG. 2 shown, the present invented cool fan (1) places a recess (116) on the bottom of front side of the basis (11) to support individual card reader (1A), HUB (1B), hard disk (1C) or radio device (1D), and meanwhile, the apparatus additionally has a signal line (18) and plug (19) for connecting to the computer in order to increase its function and flexibility.

The connecting plug (17) and plug (19) described above can be the connecting terminal of the USB, 1394 and PS2.

1. The cooling fan having a fan inside the cooling fan case has connecting plug on its power line end to connect to arbitrary outlets of mobile computer, computer host, or the hub of the USB, 1394 and PS2 in order to draw electrical power to turn on the fan for cooling purpose.

2. The cooling fan of claim 1, wherein there is a speed tuner inside the cooling fan and places an arc knob on the top for the user to turn the arc knob to control rotating speed.

3. The cooling fan of claim 1, wherein there is a positioning reed inside the basis and places a pen stand on the side for adjusting the elevation angle of the cooling fan and being convenient for pen placement.

4. The cooling fan of claim 1, wherein the front shell is capable of with light, or additionally places a LED light inside the front shell to have lighting effect for the front shell while turn-on the cool fan.

5. The cooling fan of claim 3, wherein there is a recess on the bottom of front side of the basis to support individual card reader, HUB, hard disk or radio device, and additionally has a signal line and plug for connecting to the computer.

6. The cooling fan of claim 1, wherein the connecting plug and the plug can be the connecting terminal of the USB, 1394 and PS2.

7. The cooling fan of claim 4, wherein the connecting plug and the plug can be the connecting terminal of the USB, 1394 and PS2.
